(19) United States
(12) Patent Application Publication
(10) Pub. No.: US 2014/0122916 A1
(43) Pub. Date: May 1, 2014

(54) REDUCING THE OVERHEAD ASSOCIATED WITH FREQUENCY CHANGES IN PROCESSORS

(71) Applicants: Guadalupe J. Garcia, Chandler, AZ (US); Lakshminarayan K. Jagannathan, Chandler, AZ (US); David Puffer, Chandler, AZ (US)

(72) Inventors: Guadalupe J. Garcia, Chandler, AZ (US); Lakshminarayan K. Jagannathan, Chandler, AZ (US); David Puffer, Chandler, AZ (US)

(21) Appl. No.: 13/664,511

(22) Filed: Oct. 31, 2012

(51) Int. Cl. G06F 1/08

(52) U.S. Cl. 713/503

(57) ABSTRACT

In many cases, processors may change frequency sufficiently often to result in significant performance and power consumption losses. These performance and power consumption losses may be mitigated by changing the frequency using a squashing technique rather than using a phase locked loop technique. The squashing technique involves simply eliminated clock pulses to reduce the frequency. This can be done more quickly, resulting in less overhead in some cases.

### BACKGROUND

This relates generally to processors and particularly to processors that implement a mode wherein the frequency of the processor may change.

Typically, processors may change their operating frequency in a number of different cases. For example, in some processors, power may be shared between different components of a platform that includes a processor. When the processor's performance requirements are decreased, the processor can utilize less power by decreasing frequency and dropping its supply voltage by a corresponding amount. However, even after the supply voltage is dropped below a minimum voltage, additional power savings may be achieved by continuing to decrease frequency.

Each time frequency is changed, a particular workload is stopped from executing to allow a phase locked loop to lock to a new frequency. The phase locked loop is used by the processor to adjust the output clock to a desired frequency. The phase locked loop lock time is an overhead as are other handshaking protocols and rate of change of current versus rate of change of time mitigation. These overheads cause different sections of logic to turn on on a staggered basis.

As a result, the overhead associated with the frequency changes may result in a substantial time delay. If frequency changes occur often enough, there may be a substantial performance overhead. Not only is there a performance loss, but there may also be a power consumption cost as well because the devices are consuming power during the time used to change the frequency.

### BRIEF DESCRIPTION OF THE DRAWINGS

Some embodiments are described with respect to the following figures:

FIG. 1 is a depiction of a plurality of clocks before and after squashing in accordance with some embodiments;

FIG. 2 is a flow chart for a squashing sequence according to one embodiment;

FIG. 3 is a depiction of a processor for one embodiment;

FIG. 4 is a system depiction for one embodiment; and

FIG. 5 is a front elevational view for one system.

FIG. 6 is a depiction of two clock signals running at a 5:4 ratio.

FIG. 7 is a series of clock signals at different ratios.

### DETAILED DESCRIPTION

In many cases, processors may change frequency so often that non-optimal performance and power consumption may result. These performance and power consumption losses may be mitigated by changing the frequency using a squashing technique rather than using a phase locked loop technique. The squashing technique may involve eliminating clock pulses to reduce the frequency. This can be done more quickly, resulting in less overhead in some cases.

As one example of an application for some embodiments of the present invention, a turbo embodiment may involve a processor that changes its frequency on a regular basis. This enables that processor to share power with other platform components. Especially on a system on a chip (SOC) turbo implementation, a frequency change may be requested on the order of every millisecond, with each frequency change costing about forty microseconds.

Frequency scaling may be required after the supply voltage Vcc is already at its minimum voltage. Once the supply voltage is at its minimum, the frequency can be reduced by eliminating the number of clock edges that are seen over a period of time.

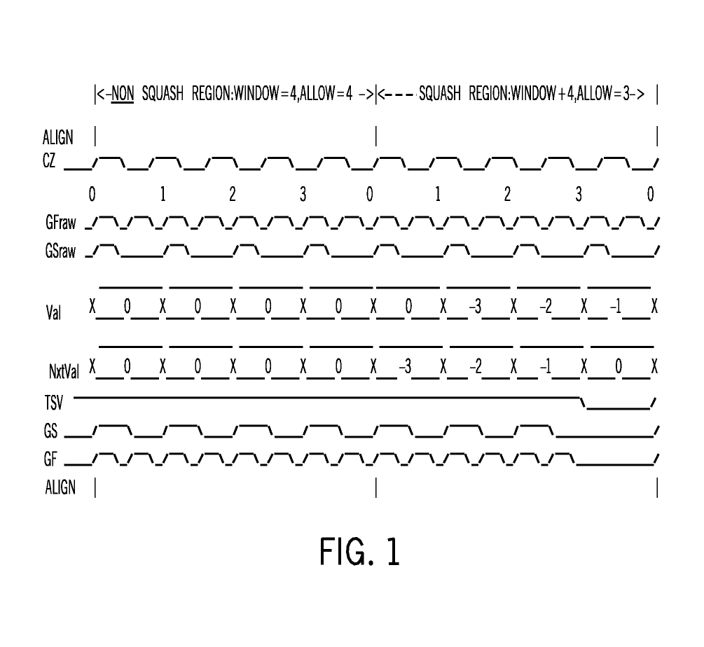

FIG. 1 shows a series of clocks titled CZ, GFraw, and GSraw at the top. While the clocks involved may be any clock, in some embodiments, the CZ clock domain is a system agent clock that happens to run at ¼ the system memory clock rate. Other generic and non-generic clock domains may be used. GF and GS clocks may be the graphics clocks that run at a ratio relative to each other. For example a 2:1 ratio between GF or graphics fast and GS or graphics slow clocks may be used. GF and GS may be generated from a phase locked loop and CZ may be generated from a different phase locked loop. But there are also modes where they both come from the same phase locked loop.

On the left in FIG. 1 is a region labeled as a non-squash region and marked by the first two align marks where none of the pulses are squashed or eliminated. On the right there is a region labeled squash region where one or more pulses may be eliminated. In the top three signals there is no squashing that occurs in GF or GS which are therefore labeled CZ, GFraw and GSraw. Then a value (Val) and a value NxtVAL (explained below) are shown. That specification calls for a Time Slot Valid (TSV) to go to zero at the end of the squash region. This results in squashing or elimination of pulses in both the graphics slow (GS) and graphics fast (GF) clocks.

The value GSraw can be a clock that is running. A TSV algorithm examines this free-running clock GSraw and creates a clock gate value known as a TSV. When the TSV equals one, the clocks can run and when TSV equals zero (e.g. at the end of the squash window), the clock is masked in one embodiment. The TSV algorithm can be applied to GSraw and masks both the final GS and GF clock as the ratio is to be maintained at the endpoints.

Window and Allow can change when the two clocks align, marked with the bars on the signal “align” in FIG. 1. The masking may be implemented with a bubble generator either first in, first out or BGF. An algorithm for performing the squashing can be as follows:

```
Val = Init = −2
If(Window=Allow)
    ClockEn=1
    NxtVal = Init
elsif (Val >= 0)
        NxtVal = Val − Allow
else
        NxtVal = CurrentValue + (Winidow − Allow)
endif
If (NxtVal < 0) ClockEn=1 else ClockEn=0
```

As another example, shown in FIG. 6, two clocks are running at a 5:4 ratio where CZ equals two hundred MHz, GF equals three hundred twenty MHz, and GS equals one hundred sixty MHz. By squashing one of four destination edges, a new average achieved frequency has a 5:3 ratio, where CZ equals two hundred, GF equals two hundred forty and GS equals one hundred twenty MHz.

This example illustrates an increment of eighty MHz achieved by squashing edges. Finer granularities can be achieved by multiplying the ratio by an integer value. For example instead of starting at a 5:4 ratio, the ratio may be 10:8. By squashing one of the eight destination edges, a forty MHz increment may be achieved. The following illustrates how the granularity can be reduced by increasing the ratio and having the capability to eliminate one clock per ratio:

5:3 CZ=200, GF=240, GS=120, GF granularity=80 MHz
10:7 CZ=200, GF=280, GS=140, GF granularity=40 MHz
20:15 CZ=200, GF=300, GS=150, GF granularity=20 MHz
40:31 CZ=200, GF=310, GS=155, GF granularity=10 MHz
80:63 CZ=200, GF=315, GS=157.5, GF granularity=5 MHz

In the example above, when CZ equals two hundred megaHertz and the ratio is 5:4, and that frequency change is to occur once every millisecond, the ratio can be expanded to two thousand to sixteen hundred. In this example, the granularity of 1/1600 can be achieved or 0.000625 megaHertz.

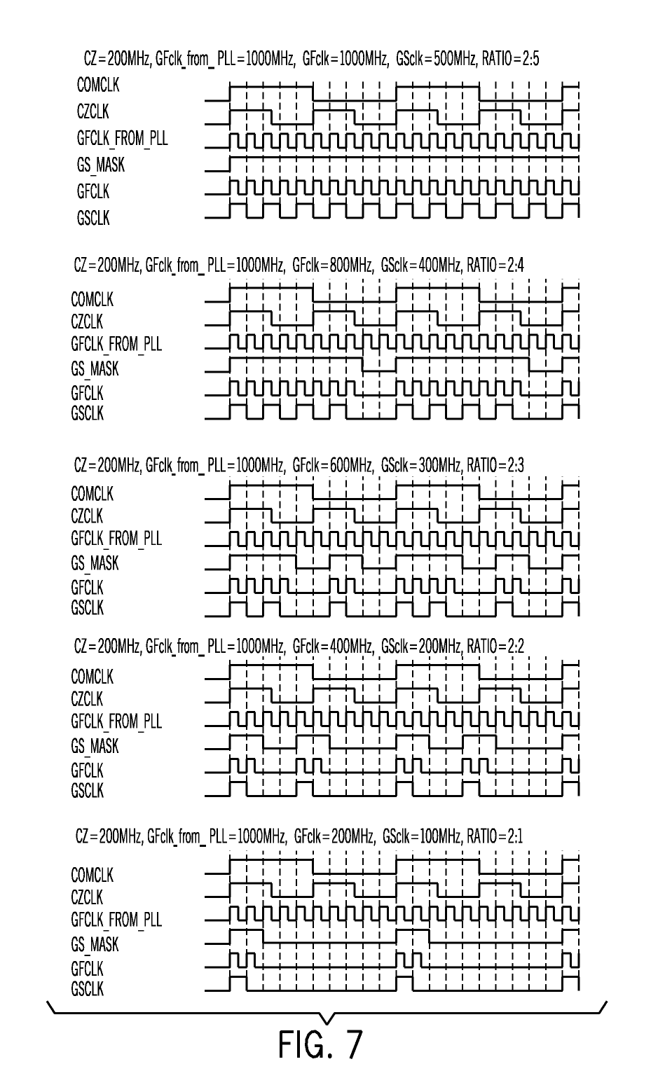

The diagrams included in FIG. 7 show the deterministic synchronous nature of the different clocks involved are maintained through the frequency change:

CZ clock is the clock that must continue to run at a fixed frequency.
CFclk_from_PLL is the graphics clock being delivered by the PLL to the logic.
CFclk is the clock being received by the logic.
GSclk is the clock being received by the logic. In this example, GF=2*GS.
COMclk is an imaginary clock showing when each clock will have a rising edge in common.

### CZ=200 MHz, GFclk_from_PLL=1000 MHz, GFclk=1000 MHz, GSclk=500 MHz,

### Ratio=2:5

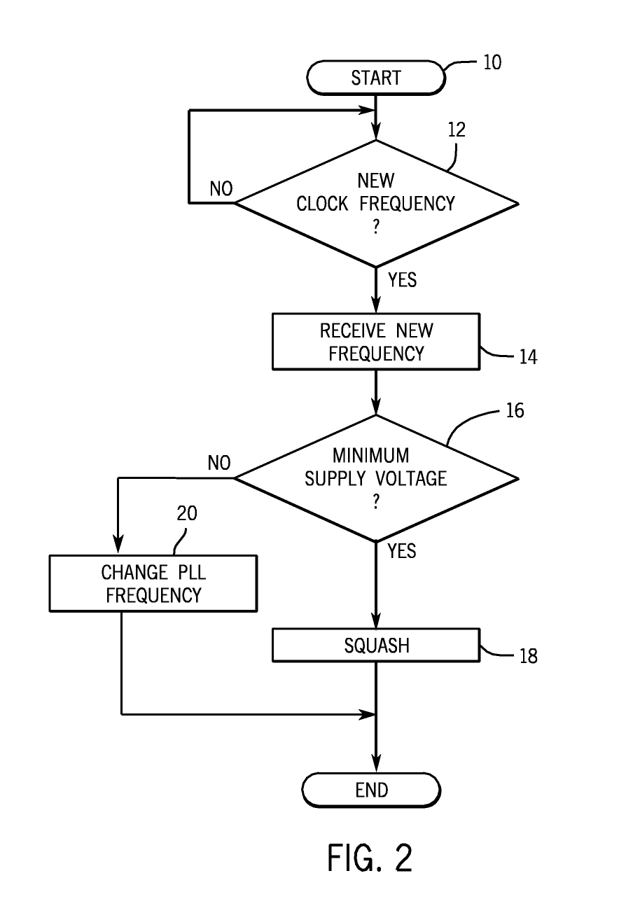

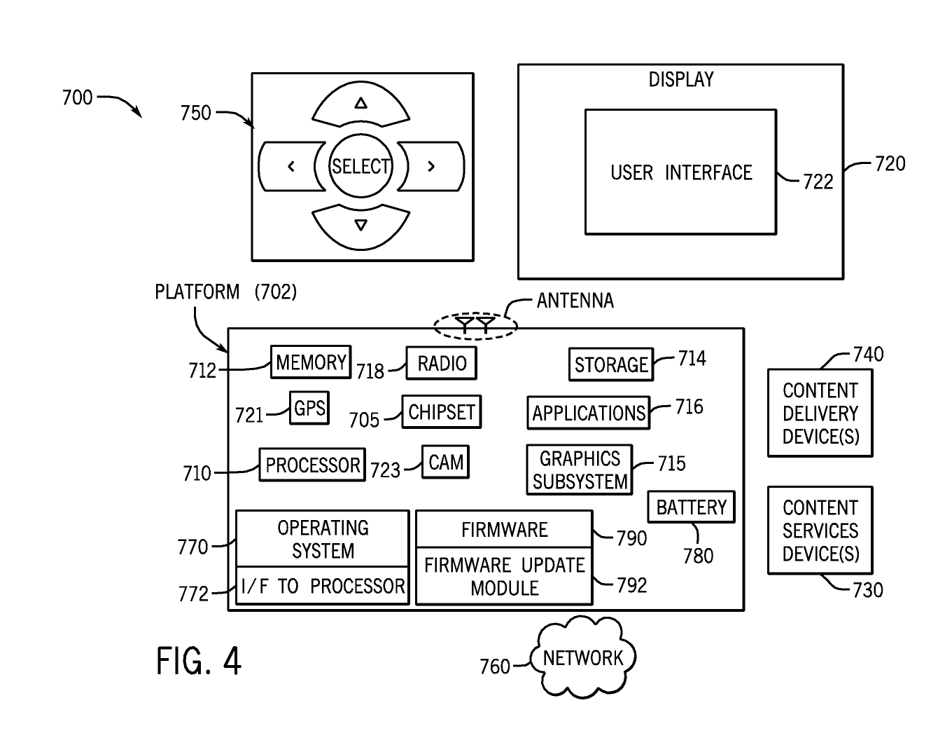

Referring to FIG. 2, a sequence for squashing pulses according to one embodiment may be implemented in software, firmware and/or hardware. In software and firmware embodiments it may be implemented by computer implemented instructions stored in one or more non-transitory computer readable media such as a magnetic, optical or semiconductor storage. For example, a graphics subsystem may perform the sequence in one embodiment (see graphics subsystem 715c in FIG. 4).

In one embodiment, the squashing sequence 10 shown in FIG. 2 begins by determining whether a new clock frequency has been requested as indicated in diamond 12. In one embodiment this may occur in the course of a turbo embodiment where it is desired to reduce the clock signal frequency provided to a processor, to conserve power and to make power available to other system components. If there is new frequency that is needed, then a new clock frequency may be received at block 14. This may indicate the desired end ratio and how fine a granularity of steps may be used to achieve that ratio.

If there is a desire to change the clock frequency, a check at diamond 16 determines whether the processor is already operating at its minimum supply voltage. If so, the frequency may be changed using clock squashing. The granularity of the squashes and the steps, if any, to achieve the squash frequency may be received in block 14.

However, if the processor is not already operating at its minimum supply voltage and particularly if it is operating in the voltage scaled region, then the frequency may be changed by changing the phase locked loop frequency as indicated in block 20. Thus, in some embodiments, the clock squashing is only used when the processor is already at its minimum supply voltage and, otherwise, conventional frequency change techniques may be used. However, in other embodiments, clock squashing may be used in other cases as well.

In some embodiments, instead of changing the phase locked loop, squashing can be used because it may have as little as zero frequency change overhead. In addition, finer frequency granularities may be achieved and lower frequencies may be possible.

Of course, the clock frequencies can also be increased by reducing or eliminating the squashing all at once or by increasing or decreasing in stepwise over time.

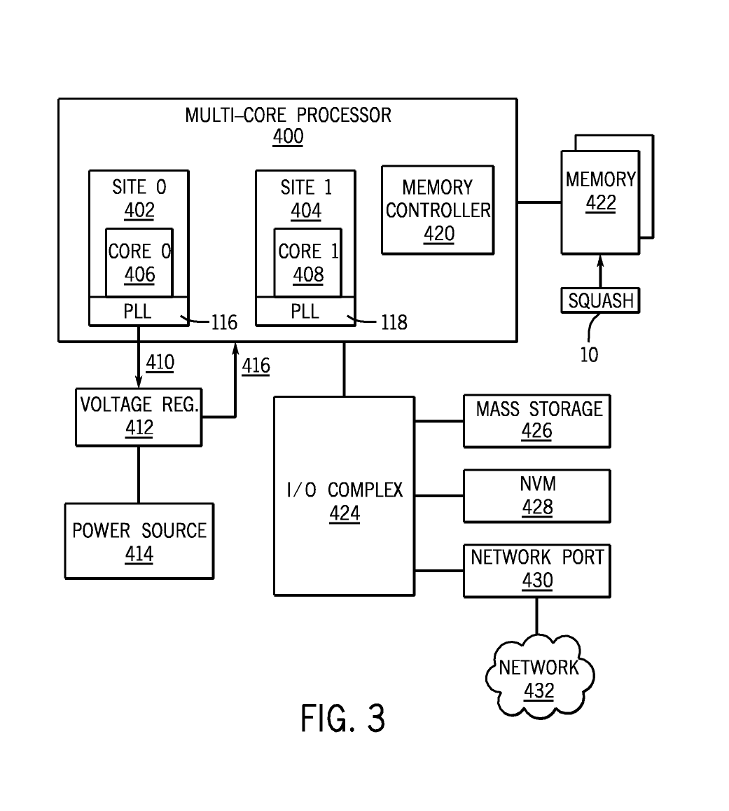

Referring to FIG. 3, a system in accordance with one embodiment is illustrated. In some embodiments a system on a chip may be illustrated. In FIG. 3, a multicore processor 400 may include a core zero 406 and a core one 408. The two sites 402 and 404 may each include a single processor core 406 or 408. In other embodiments, the number of cores per site may be more than one. For example, in other embodiments there may two or four cores per site or more. Each site includes a phase locked loop (PLL) 116 or 118.

The site 402 may be a master site that controls the voltage supplied to the processor by sending a voltage information signal 410 to the voltage regulator 412. The voltage regulator 412 receives power supply from a power source 414 and regulates the voltage specifically supplied to the processor 416. Logic within the site zero 402 can continuously modify the supplied voltage 416 by sending new voltage information signals 410 at any given time to the voltage regulator 412.

In addition, the system may include an input/output complex 424. That complex may have one or more integrated input/output host controllers to control communication between the multicore processor 400 and one or more peripheral devices such as a mass storage device 426 (e.g. a hard disk drive), a non-volatile memory storage 428, and a network port 430 that provides access between the computer system and the network 432. The input/output host controllers may utilize one or more different input/out interfaces such as a Universal Serial Bus (USB) interface, the Peripheral component interconnect (PCI) Express®, or Institute of Electrical and Electronic Engineers 1394 Firewire interface or one or more other input/output interfaces.

In many embodiments that are not shown, a graphics processing unit may be coupled to the multicore processor 400 or integrated into the multicore processor 400 to provide information to a display device such as a monitor for viewing information by the user.

FIG. 4 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequence shown in FIG. 2 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

As described above, system 700 may be embodied in varying physical styles or form factors. FIG. 4 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

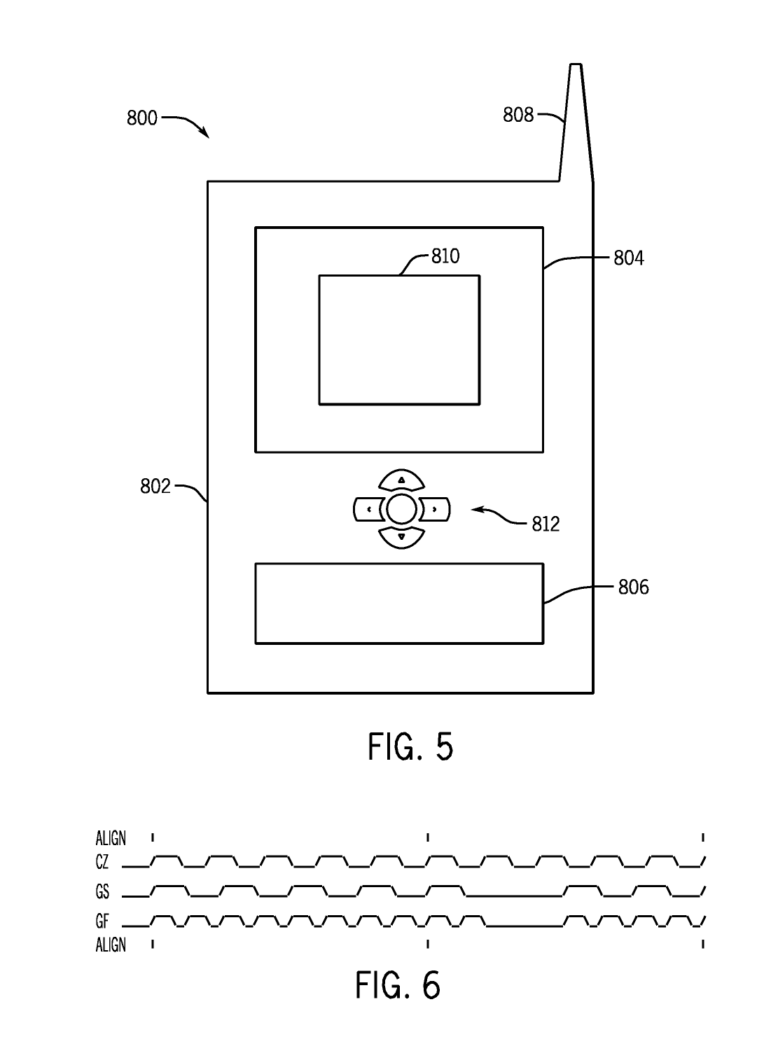

As shown in FIG. 5, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

The following clauses and/or examples pertain to further embodiments:

One example embodiment may be a method changing a processor clock frequency by squashing a clock edge. The method may include selecting a desired frequency and squashing at least one clock edge to achieve said frequency. The method may also include achieving the frequency by squashing clock edges in steps. The method may also include determining how many edges to squash to achieve a target frequency. The method may also include implementing a system on a chip turbo. The method may also include using squashing to adjust the frequency ratio between two clocks.

Another example embodiment may include at least one non-transitory computer readable medium storing instructions to change a processor clock frequency by squashing a clock edge. The medium may also include storing instructions to select a desired frequency and squash at least one clock edge to achieve said frequency. The medium may also include storing instructions to achieve the frequency by squashing clock edges in steps. The medium may also include storing instructions to determine how many edges to squash to achieve a target frequency. The medium may also include storing instructions to implement a system on a chip turbo. The medium may also include storing instructions to use squashing to adjust the frequency ratio between two clocks.

Another example embodiment may include a processor comprising a core to change to a processor clock frequency by squashing a clock edges; and a phase locked loop coupled to said core. The processor may include said core to select a desired frequency and squash at least one clock edge to achieve said frequency. The processor may also include said core to achieve the frequency by squashing clock edges in steps. The processor may also include said core to determine how many edges to squash to achieve a target frequency. The processor may also include said core to implement a system on a chip turbo. The processor may also include said core to use squashing to adjust the frequency ratio between two clocks.

And still another example embodiment may comprise a processor including a core to change to a processor clock frequency by squashing a clock edges, and a phase locked loop coupled to said core; and a memory coupled to said processor. The system may also include said processor to select a desired frequency and squash at least one clock edge to achieve said frequency. The system may also include said processor to achieve the frequency by squashing clock edges in steps. The system may also include said processor to determine how many edges to squash to achieve a target frequency. The system may also include said processor to implement a system on a chip turbo. The system may also include said processor to use squashing to adjust the frequency ratio between two clocks. The system may also include an operating system, a battery and firmware and a module to update said firmware.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
changing a processor clock frequency by squashing a clock edge.

2. The method of claim 1 including determining if a processor is operating at its minimum supply voltage and if so squashing a clock edge.

3. The method of claim 2 including if the processor is in voltage scaled region, changing clock frequency using a phase locked loop.

4. The method of claim 1 including selecting a desired frequency and squashing at least one clock edge to achieve said frequency.

5. The method of claim 2 including achieving the frequency by stepwise squashing clock edging.

6. The method of claim 2 including determining how many edges to squash to achieve a target frequency.

7. The method of claim 1 including using squashing to adjust the frequency ratio between two clocks.

8. At least one non-transitory computer readable medium storing instructions that when executed by a processor cause the processor to change a processor clock frequency by squashing a clock edge.

9. The medium of claim 8 further storing instructions to select a desired frequency and squash at least one clock edge to achieve said frequency.

10. The medium of claim 9 further storing instructions to achieve the frequency by squashing clock edges in steps.

11. The medium of claim 9 further storing instructions to determine how many edges to squash to achieve a target frequency.

12. The medium of claim 10 further storing instructions to use squashing to adjust the frequency ratio between two clocks.

13. The medium of claim 8 further storing instructions to determine if the processor is operating at its minimum supply voltage.

14. The medium of claim 13 further storing instructions to use clock squashing if the processor is operating at its minimum supply voltage.

15. The medium of claim 13 further storing instructions to use a phase locked loop to change clock frequency when the processor is not operating at its minimum supply voltage.

16. A processor comprising:
a core configured to change to a processor clock frequency, wherein to change, the core is to cause a clock edge squash; and
a phase locked loop coupled to said core.

17. The processor of claim 16 said core to select a desired frequency and squash at least one clock edge to achieve said frequency.

18. The processor of claim 17, wherein to achieve the frequency, said core is to squash clock edges in steps.

19. The processor of claim 16 said core to determine how many edges to squash to achieve a target frequency.

20. The processor of claim 16 said core to implement a system on a chip turbo.

21. The processor of claim 16 said core to squash to adjust the frequency ratio between two clocks.

22. The processor of claim 16 said core to use clock squashing if the processor is operating at its minimum supply voltage.

23. The processor of claim 16 said core to use the phase locked loop to change clock frequency when the processor is not operating at its minimum supply voltage.

24. A system comprising:
a processor including a core to change to a processor clock frequency and squash clock edges, and a phase locked loop coupled to said core; and
a display coupled to said processor.

25. The system of claim 24 said processor to select a desired frequency and squash at least one clock edge to achieve said frequency.

26. The system of claim 25 said processor to achieve the frequency and squash clock edges in steps.

27. The system of claim 25 said processor to determine how many edges to squash to achieve a target frequency.

28. The system of claim 24 said processor to use squashing to adjust the frequency ratio between two clocks.

29. The system of claim 24 said core to use clock squashing if the processor is operating at its minimum supply voltage.

30. The system of claim 24 said core to use the phase locked loop to change clock frequency when the processor is not operating at its minimum supply voltage.
